(19) United States
(12) Patent Application Publication
(10) Pub. No.: US 2010/0258143 A1
(43) Pub. Date: Oct. 14, 2010

(54) SCRUBBER CLEAN BEFORE OXIDE CHEMICAL MECHANICAL POLISH (CMP) FOR REDUCED MICROSCRATCHES AND IMPROVED YIELDS

(75) Inventor: Jacob L. Williams, Gilbert, AZ (US)

Correspondence Address: King & Spalding LLP, 401 Congress Avenue, Suite 3200, Austin, TX, 78701, US

(73) Assignee: Microchip Technology Incorporated

(21) Appl. No.: 12/730,003

(22) Filed: Mar. 23, 2010

Related U.S. Application Data
(60) Provisional application No. 61/212,581, filed on Apr. 13, 2009.

(51) Int. Cl. B08B 1/00; B08B 13/00

(52) U.S. Cl. 134/6; 134/95.2; 15/21.1

(57) ABSTRACT

A method for fabricating semiconductors is provided that includes an oxide chemical mechanical polish (CMP) step. Prior to performing the CMP of an integrated circuit semiconductor silicon wafer, a number of steps are performed. The silicon wafer is scrubbed with a brush using a liquid cleaner. The silicon wafer is rinsed with deionized water (DIW). Finally, the silicon wafer is dried.

### CROSS-REFERENCE To RELATED APPLICATION

This application claims the benefit of U.S. Provisional Application No. 61/212,581 filed on Apr. 13, 2009, entitled “SCRUBBER CLEAN BEFORE OXIDE CHEMICAL MECHANICAL POLISH (CMP) FOR REDUCED MICROSCRATCHES AND IMPROVED YIELDS”, which is incorporated herein in its entirety.

### TECHNICAL FIELD

The present disclosure relates to fabrication of integrated circuit devices, and, more particularly, in performing a scrubber clean before Oxide Chemical Mechanical Polish (CMP) that removes surface particles from the oxide surface, thereby removing a microscratch source and drastically reducing microscratches.

### BACKGROUND

Semiconductor fabrication involves the precise creation of extremely small features on a disk of semiconductor material, typically a wafer made of pure, crystallized silicon. During this semiconductor fabrication process, a complex series of steps are performed to successively add or remove patterns of material on this wafer in order to create a number of tiny electrical or micromechanical components. As with any high-precision process, unintended particles may cause defects, and some defects can render the finished product unusable. Thus, silicon fabrication facilities employ various systems to prevent extraneous solid particles, including dust and smoke particles as well as material left over from previous process steps, from circulating around or coming into contact with the silicon wafer. No filtration system is perfect and some particles may be generated by the fabrication process itself.

One specific problem caused by these unintended particles is the creation of microscratches in the surface of the silicon wafer or the layers that have been deposited on the silicon wafer that can damage or interfere with the function of the manufactured electrical or micromechanical components. These microscratches may be caused during the silicon dioxide (hereinafter, “oxide”) chemical mechanical polish (CMP) step. At this step, unintended particles are moved across the surface of the silicon wafer (hereafter meant to include any material deposited on the silicon wafer) and may scratch the surface in the process. As a result, the unintended particles are removed from the surface of the silicon wafer, but lasting damage has occurred in the form of microscratches. These microscratches may end up filled with metal (tungsten, copper, or other metallization depending on the scheme). These metal fillings can short-circuit electrical components or even cause intermittent or delayed problems with the electrical or micromechanical features. As a result, a number of component blocks may be unusable (reducing the effective yield of the process) or may be unreliable when deployed by end-users in computers, cell phones, automobiles, and the like.

Removal of particles prior to CMP has not been previously considered for a number of reasons. First, CMP is perceived as a “dirty” process and it is not intuitive to scrub or clean the wafer prior to performing a dirty process. Second, prior art efforts have focused on reducing scratch sources that originate in the CMP process, such as slurry particles, pad materials, pad conditioning, wafer handling mechanisms, and the like. Third, other prior art efforts have focused on reducing the impact of scratches once they have occurred. For example, some of these mitigation techniques include performing a soft polish or buff to remove scratches, polishing with a less aggressive slurry at the end of the process, and polishing beyond the desired film thicknesses then redepositing more of the oxide film to “fill in” the scratches. Finally, prior art scrubber processes were typically focused on removing small slurry particles, not large particulates from other prior processing steps.

### SUMMARY

In accordance with the teachings of the present disclosure, disadvantages and problems associated with existing semiconductor fabrication approaches have been reduced.

In certain embodiments, a method for fabricating semiconductors is provided that includes an oxide chemical mechanical polish (CMP) step. Prior to performing the CMP of an integrated circuit semiconductor silicon wafer, a number of steps are performed. The silicon wafer is scrubbed with a brush using a liquid cleaner. The silicon wafer is rinsed with deionized water (DIW). Finally, the silicon wafer is dried.

In certain embodiments, a system for fabricating semiconductors is provided that is configured to perform an oxide CMP step. The system of this embodiment is further configured to, prior to performing the CMP of an integrated circuit semiconductor silicon wafer, perform a number of steps. The system is configured to scrub a silicon wafer with a brush using a liquid cleaner; rinse the silicon wafer with DIW; and dry the silicon wafer.

In certain embodiments, a method for reducing microscratches caused by oxide CMP of an integrated circuit semiconductor silicon wafer is provided. The method is performed before oxide CMP. The method of this embodiment includes providing a first DIW or chemical brush scrub using dilute ammonium hydroxide (NH₄OH) and a polyvinyl alcohol (PVA) brush to the silicon wafer, wherein the NH₄OH dilution is from about 20:1 to about 1500:1; rinsing the silicon wafer with the DIW; providing a second DIW or chemical brush scrub using dilute hydrofluoric acid (HF) and a PVA brush to the silicon wafer, wherein the HF dilution is from about 5:1 to about 500:1; rinsing the silicon wafer with the DIW; spin rinsing the silicon wafer with the DIW, wherein the silicon wafer preferably rotates at about 2500 revolutions per minute; and drying the silicon wafer with heated nitrogen gas (N₂), wherein the N₂ drying temperature is between about 30 degrees C. and about 150 degrees C.

Other technical advantages of the present disclosure will be readily apparent to one skilled in the art from the following figures, descriptions, and claims. Various embodiments of the present application may obtain only a subset of the advantages set forth. No one advantage is critical to the embodiments.

### BRIEF DESCRIPTION OF THE DRAWINGS

A more complete and thorough understanding of the present disclosure and advantages thereof may be acquired by referring to the following description taken in conjunction with the accompanying drawings, in which like reference numbers indicate like features. Preferred embodiments of the invention and its advantages are best understood by reference to FIGS. 1-5.

FIGS. 1a and 1b illustrate problems in prior art techniques including the effect of a microscopic particle remaining on the surface of a semiconductor die when the CMP process begins;

FIGS. 2a and 2b illustrate test results of semiconductor wafers fabricated using prior art techniques including the effect of a microscopic particle remaining on the surface of a semiconductor die when the CMP process begins;

FIG. 3 illustrates a distinction between the prior art process and the process of the present disclosure, according to certain embodiments;

FIG. 4 illustrates graphical data showing a distinction between microscratch defect density using the prior art process and that of the present disclosure, according to certain embodiments; and

FIG. 5 illustrates a flowchart of an example method of the present disclosure, according to certain embodiments.

### DETAILED DESCRIPTION

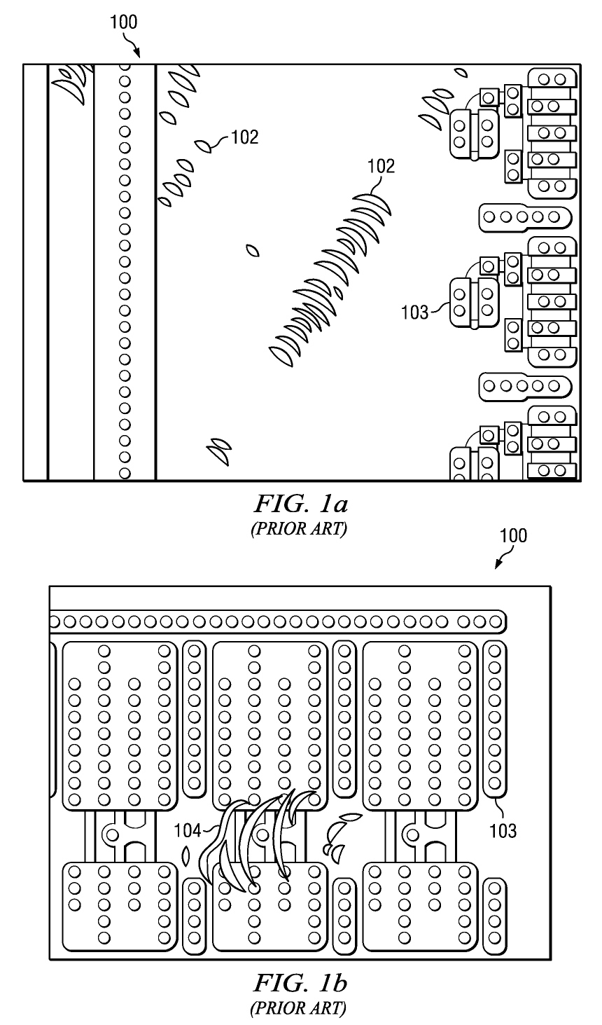

Preferred embodiments and their advantages over the prior art are best understood by reference to FIGS. 1-5 below.

FIGS. 1a and 1b illustrate problems in prior art techniques including the effect of a microscopic particle remaining on the surface of a semiconductor die when the CMP process begins.

FIG. 1a is an enlarged, and cropped, view of silicon wafer 100 including microscratches 102 and semiconductor features 103. Silicon wafer 100 may be a slice of silicon crystal forming a thin cylinder having a circular surface several inches wide and a thickness of a tiny fraction of an inch. During the semiconductor fabrication process, silicon wafer 100 may be sequentially deposited with various chemical compounds, exposed to a radiation source (typically light), and exposed to various etching chemicals. The process generates various features 103, which are precisely arranged semiconductor components and connections. Features 103 may be memory units, logical gates, micromechanical components, amplifiers, antennae, wires, capacitors, inductors, or other electrical and/or mechanical components.

Features 103 are grouped logically into individual dice, which may be separated at a later time. Each die may form the basis for an individual semiconductor device (e.g., a microcontroller). Each die may be tested to identify manufacturing defects. The percentage of dice that pass these tests out of the total number fabricated is known as the yield of the process. Clearly, a higher yield is better as there is less waste. Each feature 103 may measure a fraction of a micrometer across, or much smaller than a human hair or a grain of sand. Modern fabrication facilities may employ various techniques (e.g., positive air pressure facilities, high-efficiency air filtration, and sealed transportation cartridges) to minimize the occurrence of impurities in the fabrication environment. Unfortunately, these techniques are not, and cannot be completely effective, resulting in the presence of microparticles in the fabrication environment. Also, some debris may result from various process steps, thus generating new microparticles.

Once certain features have been created, a CMP step is commonly performed to ensure a generally uniform thickness of the wafer. This may be referred to as planarization of the wafer. This uniform thickness may allow the creation of a multi-layer structure. The CMP step may involve the use of abrasives and reactive chemicals. During this CMP process, the microparticles may end up ground into the surface of silicon wafer 100 during the CMP process. The resulting microscratches 102 may be about the same size as features 103. Microscratches 102 may occur anywhere on the surface of wafer 100.

FIG. 1b is another enlarged, and cropped, view of silicon wafer 100 including semiconductor features 103 and microscratches 104. As can be seen from the image, microscratches 104 come in contact with features 103. In some instances, microscratches 104 may indicate physical damage to one or more of features 103. Such damage may involve complete destruction (e.g., a logic gate that no longer functions) or impaired function of the damaged feature 103. Alternatively, the damage to feature 103 could result in a premature failure of that feature. In some situations, microscratch 104 could be filled with metal (e.g., tungsten) in a subsequent processing step. This new, and unintended, conduction path may short two or more features 103. This would, in effect, rewire the circuit in an unintended way and could significantly alter or impair the designed function of the larger semiconductor device.

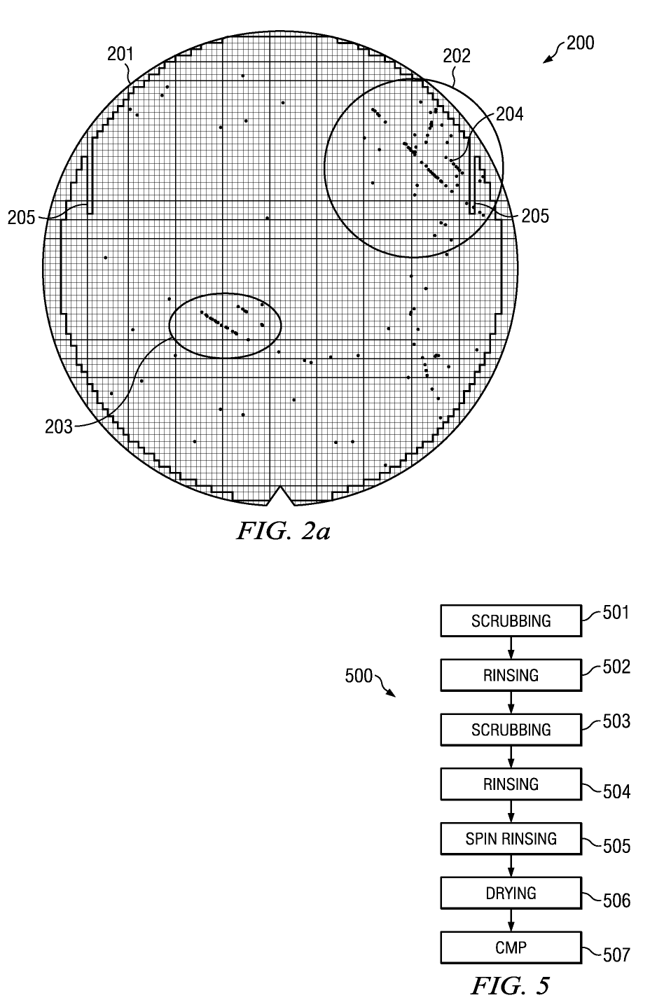

FIGS. 2a and 2b illustrate test results of semiconductor wafers fabricated using prior art techniques including the effect of a microscopic particle remaining on the surface of a semiconductor die when the CMP process begins.

FIG. 2a is an in-line wafer map generated by a surface inspection tool. Defect analysis image 200 includes analysis area 201, areas of interest 202 and 203, and identified defects 204. The surface inspection tool may perform an optical analysis to identify potential defects as part of a quality control process step. Analysis area 201 shows the entire wafer surface, which may include multiple dice (e.g., chips to be separated, packaged, and used as a component in a larger circuit). Areas of interest 202 and 203 include patterns or clusters of identified defects 204. Each area of interest 202 and 203 contains a pattern indicating a long scratch or series of scratches in the surface of the material that may have been created when a microparticle was carried across the surface during the CMP step.

FIG. 2b is a probe wafer map generated by a probe inspection tool. Defect analysis image 210 includes analysis area 211, areas of interest 202 and 203, and identified defects 212. The probe inspection tool may perform an electrical test using physical probes to identify defects as part of another qualify control process step. The tested wafer illustrated in FIG. 2b is the same wafer as was examined in FIG. 2a and areas of interest 202 and 203 are drawn to generally correspond to the same portions of the wafer. Area of interest 202 shows a linear defect pattern generally corresponding to the possible defect pattern shown in FIG. 2a in the same location on the wafer. Thus, the visually identified potential defects shown in FIG. 2a generally correspond to the actual defects identified by the probe inspection tool.

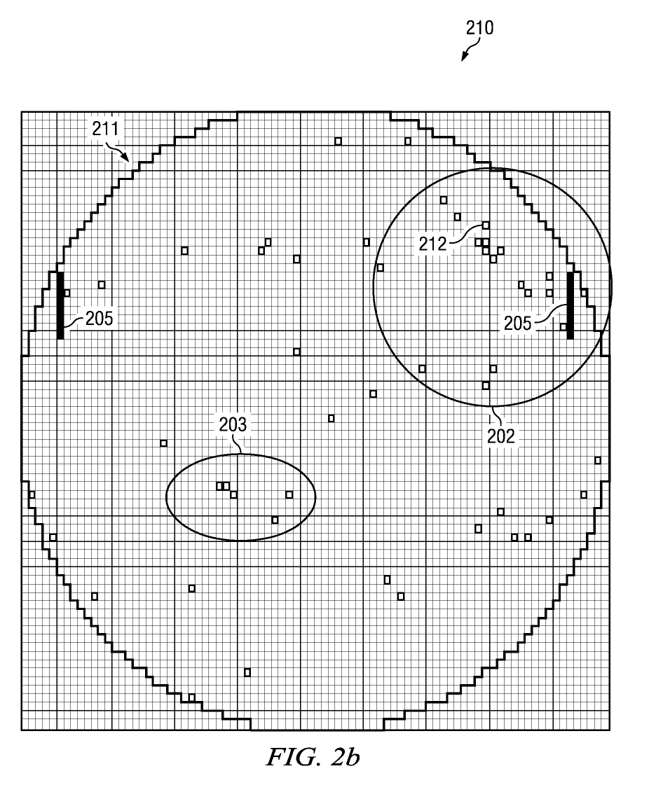

FIG. 3 illustrates a distinction between the prior art process and the process of the present disclosure, according to certain embodiments. Process diagram 300 illustrates silicon wafer 100 with surface particle 301 and microscratches 102. Also illustrated are process steps of scrubbing 302 and CMP 303. Surface particle 301 may be dust, a fragment of a silicon wafer, or any other type of material on the surface of wafer 100. In the method of the present disclosure, scrubbing step 302 (which may comprise multiple sub-steps) is performed and removes surface particle 301 from the surface of wafer 100. CMP 303 is then performed on the particle-free wafer 100. As a result, wafer 100 remains generally free of microscratches 102. Alternatively, if CMP 303 is performed on wafer 100 with microparticle 301 in place (as in the prior art method), microscratches 102 may be formed.

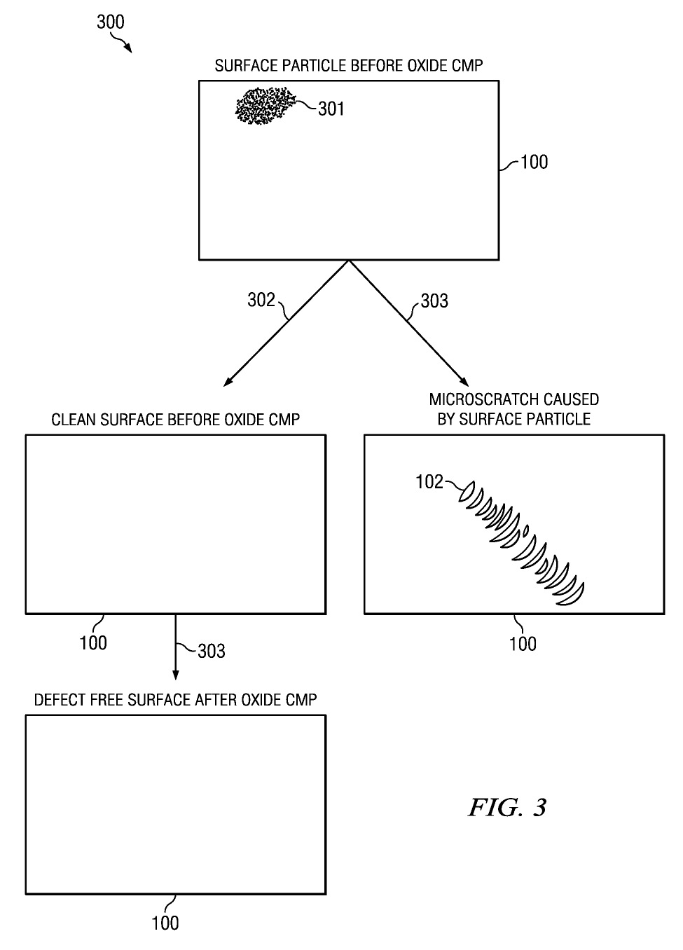

FIG. 4 illustrates graphical data showing a distinction between microscratch defect density using the prior art process and that of the present disclosure, according to certain embodiments. Graph 400 illustrates normalized microscratch defect density as a function of time (measured in weeks). Data set 401 represents the microscratch defect density according to the prior art approach while data set 402 represents the microscratch defect density resulting from the presently disclosed approach. Graph 400 shows a significant reduction (of approximately 81%) in microscratch defect density when the presently disclosed approach is employed.

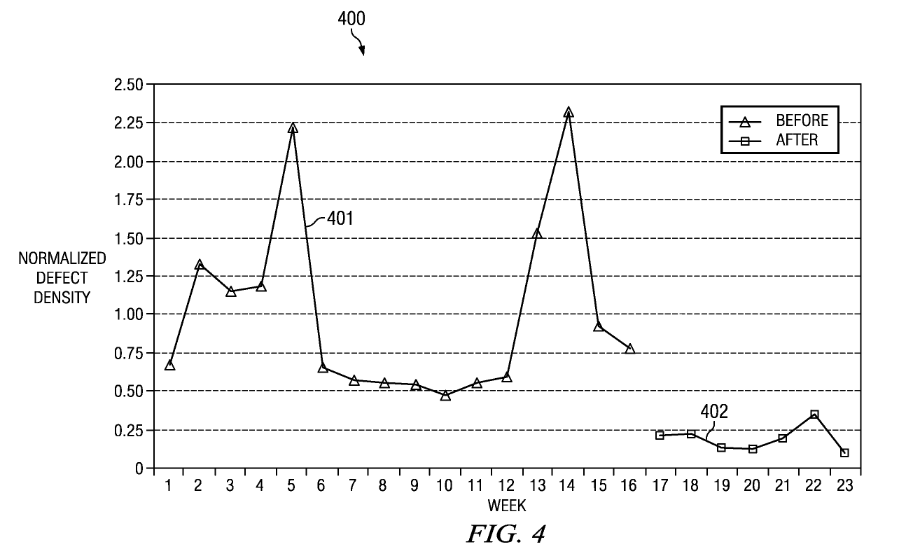

FIG. 5 illustrates a flowchart of an example method of the present disclosure, according to certain embodiments. Method 500 includes steps of scrubbing 501, rinsing 502, scrubbing 503, rinsing 504, spin rinsing 505, drying 506, and CMP 507.

Method 500 may be performed by certain embodiments of the present disclosure. Method 500 may be performed by a single fabrication machine or may be performed in part in different machines (e.g., in an assembly line approach).

Scrubbing 501 is a step for scrubbing a silicon wafer with a brush. In some embodiments, the brush may be made of polyvinyl alcohol brush (PVA). In some embodiments, scrubbing 501 may be performed with an amount of a first liquid cleaner to help lubricate and wash away any microparticles from the surface of the silicon wafer. In some embodiments, the first liquid cleaner may be deionized water (DIW). In other embodiments, the first liquid cleaner may be ammonium hydroxide (NH₄OH) in dilute form. In certain embodiments, the NH₄OH may be diluted in a range of about 20:1 to about 1500:1. In some embodiments, the NH₄OH may be diluted to about 500:1. In other embodiments, the first liquid cleaner may be hydrofluoric acid (HF) in dilute form. In certain embodiments, the HF may be diluted in a range of about 5:1 to about 500:1. In some embodiments, the HF may be diluted to about 100:1. In some embodiments, scrubbing 501 may comprise a number of sub-steps.

In certain embodiments, scrubbing 501 may be performed with multiple brushes, e.g., a topside brush and a backside brush. These two brushes may also rotate and may do so independently or in unison. These brushes may rotate a speeds of around 1000 rpm in a clockwise or counterclockwise direction and may change direction during the process. During scrubbing 501, the wafer may be rotated in the same direction as the brushes or the opposite direction and may rotate at speeds of around 20 rpm. The first liquid cleaner may be present at some times or at all times during scrubbing 501. In some embodiments, one or more of these brushes may move relative to the surface of the wafer. A brush may be oscillated to perform a scrubbing action on the wafer surface. A brush may be only partially aligned with the wafer, e.g., to perform an edge clean. A brush may be moved from mostly or completely unaligned with the wafer to near or total alignment with the wafer in a scanning motion.

Rinsing 502 is a step for rinsing the silicon wafer with DIW. This rinsing step may remove residual amounts of the first liquid cleaning agent as well as any dislodged, but still present, microparticles.

Scrubbing 503 is a step for scrubbing the silicon wafer with a brush. In some embodiments, the brush may be made of PVA. In certain embodiments, the brush used in scrubbing 503 may be the brushes used in scrubbing 501. In some embodiments, scrubbing 503 may be performed with an amount of a second liquid cleaner to help lubricate and wash away any microparticles from the surface of the silicon wafer. In some embodiments, the second liquid cleaner may be DIW. In other embodiments, the second liquid cleaner may be hydrofluoric acid (HF) in dilute form. In certain embodiments, the HF may be diluted in a range of about 5:1 to about 500:1. In some embodiments, the HF may be diluted to about 100:1. In other embodiments, the first liquid cleaner may be ammonium hydroxide (NH₄OH) in dilute form. In certain embodiments, the NH₄OH may be diluted in a range of about 20:1 to about 1500:1. In some embodiments, the NH₄OH may be diluted to about 500:1. In some embodiments, scrubbing 503 may comprise a number of sub-steps identical to or similar to scrubbing 501.

Rinsing 504 is a step for rinsing the silicon wafer with DIW. This rinsing step may remove residual amounts of the first liquid cleaning agent as well as any dislodged, but still present, microparticles.

Spin rinsing 505 is a step for rinsing the silicon wafer with DIW while spinning the wafer. In some embodiments, spin rinsing 505 may comprise a number of sub-steps and may utilize a dry task chamber.

Drying 506 is a step for drying the wafer. In some embodiments, a flow of heated nitrogen (N₂) gas may be used for drying the wafer. In some embodiments, the N₂ gas is heated to between about 30 degrees C. to about 150 degrees C. In some embodiments, the N₂ gas is heated to about 100 degrees C. In some embodiments, the wafer may be rotated during the drying process. This rotation may be at speeds of about 2500 rpm.

In some embodiments, all of the above steps may be performed using the same process equipment. In other embodiments, scrubbing 501 may be performed by different process equipment than scrubbing 503. In these other embodiments, drying 506 may be performed after rinsing 502 and after spin rinsing 505.

While embodiments of this disclosure have been depicted, described, and are defined by reference to example embodiments of the disclosure, such references do not imply a limitation on the disclosure, and no such limitation is to be inferred. The subject matter disclosed is capable of considerable modification, alteration, and equivalents in form and function, as will occur to those ordinarily skilled in the pertinent art and having the benefit of this disclosure. The depicted and described embodiments of this disclosure are examples only, and are not exhaustive of the scope of the disclosure.

What is claimed is:

1. A semiconductor fabrication method comprising:
prior to performing an oxide chemical mechanical polish (CMP) of an integrated circuit semiconductor silicon wafer:
scrubbing a silicon wafer with a brush using a liquid cleaner;
rinsing the silicon wafer with deionized water (DIW); and
drying the silicon wafer.

2. The method of claim 1, wherein the liquid cleaner is one of DIW, ammonium hydroxide (NH₄OH) diluted in the range of about 20:1 to about 1500:1, or hydrofluoric acid (HF) diluted in the range of about 5:1 to about 500:1.

3. The method of claim 2, wherein the liquid cleaner is NH₄OH diluted to about 500:1.

4. The method of claim 2, wherein the liquid cleaner is HF diluted to about 100:1.

5. The method of claim 1, wherein the brush is a polyvinyl alcohol (PVA) brush.

6. The method of claim 1, wherein drying the silicon wafer involves nitrogen gas (N₂) heated to a temperature of between about 30 degrees C. and about 150 degrees C.

7. The method of claim 1, wherein drying the silicon wafer involves N₂ heated to a temperature of about 100 degrees C.

8. The method of claim 1, further comprising, after rinsing the silicon wafer:
scrubbing the silicon wafer for a second time using a second liquid cleaner; and
spin rinsing and drying the silicon wafer.

9. The method of claim 8, wherein the two scrubbings are performed with different brushes.

10. A semiconductor fabrication system configured to:
prior to performing an oxide chemical mechanical polish (CMP) of an integrated circuit semiconductor silicon wafer:
scrub a silicon wafer with a brush using a liquid cleaner;
rinse the silicon wafer with deionized water (DIW); and
dry the silicon wafer.

11. The system of claim 10, wherein the liquid cleaner is one of DIW, ammonium hydroxide (NH₄OH) diluted in the range of about 20:1 to about 1500:1, or hydrofluoric acid (HF) diluted in the range of about 5:1 to about 500:1.

12. The system of claim 11, wherein the liquid cleaner is NH₄OH diluted to about 500:1.

13. The system of claim 11, wherein the liquid cleaner is HF diluted to about 100:1.

14. The system of claim 10, wherein the brush is a polyvinyl alcohol (PVA) brush.

15. The system of claim 10, wherein the silicon wafer is dried using nitrogen gas (N₂) heated to a temperature of between about 30 degrees C. and about 150 degrees C.

16. The system of claim 10, wherein the silicon wafer is dried using N₂ heated to a temperature of about 100 degrees C.

17. The system of claim 10, wherein the system is further configured to, after rinsing the silicon wafer:
scrub the silicon wafer for a second time using a second liquid cleaner; and
spin rinse and dry the silicon wafer.

18. The system of claim 17, wherein the two scrubs are performed with different brushes.

19. A method for reducing microscratches caused by oxide chemical mechanical polish (CMP) of an integrated circuit semiconductor silicon wafer by performing a scrubber clean before oxide CMP, said method comprising the steps of:
providing a first de-ionized water (DIW) or chemical brush scrub using dilute ammonium hydroxide (NH₄OH) and a polyvinyl alcohol (PVA) brush to the silicon wafer, wherein the NH₄OH dilution is from about 20:1 to about 1500:1;
rinsing the silicon wafer with the DIW;
providing a second DIW or chemical brush scrub using dilute hydrofluoric acid (HF) and a PVA brush to the silicon wafer, wherein the HF dilution is from about 5:1 to about 500:1;
rinsing the silicon wafer with the DIW;
spin rinsing the silicon wafer with the DIW, wherein the silicon wafer preferably rotates at about 2500 rounds per minute; and
drying the silicon wafer with heated nitrogen gas (N₂), wherein the N₂ drying temperature is between about 30 degrees C. and about 150 degrees C.

20. The method of claim 19 wherein:
the first scrub uses NH₄OH diluted to about 500:1;
the second scrub uses HF diluted to about 100:1; and
the N₂ drying temperature is about 100 degrees C.
